(19) United States
(12) Patent Application Publication
(10) Pub. No.: US 2012/0297711 A1
(43) Pub. Date: Nov. 29, 2012

(54) Drainage-Promoting Wrap

(75) Inventors: Geoffrey N. Ehrman, Doylestown, PA (US); George Caruso, Ambler, PA (US)

(73) Assignee: BENJAMIN OBDYKE INCORPORATED, Horsham, PA (US)

(21) Appl. No.: 13/114,112

(22) Filed: May 24, 2011

(51) Int. Cl. E04B 1/70; B32B 3/00; B32B 3/06

(52) U.S. Cl. 52/302.1; 428/99; 428/156

(57) ABSTRACT

A drainage-promoting wrap includes an elongate strip of weather-resistive membrane storable in a spiral roll and a series of separate, spaced-apart, spacers elements bonded to a face of the weather-resistive membrane. The spacer elements project from the face to a predetermined height and are formed of a hot-melt material applied to the membrane. A series of self-sealing fastener tabs can also be formed on the face of the membrane. Wall and roof assemblies utilizing the wrap are also provided.

### BACKGROUND

The present invention relates to moisture management within a building structure such as an exterior wall, roof or like building component.

A wall, roof or like structure of a building may include an inner sheathing member to which an exterior building material, such as exterior cladding or the like, is applied to form an exterior envelope or outer surface of the building. During wall or roof assembly, it is common practice to apply an intermediate water resistive covering or like layer over the inner sheathing members such that the water resistive covering is located between the inner sheathing members and the exterior cladding or like exterior building material. By way of example, the coverings may include building paper, tar paper, roofing felt, house or building wrap materials, and the like.

Moisture that penetrates the cladding will prematurely deteriorate the wall, roof or like building structure and permit mold growth if the moisture is permitted to accumulate therein. Thus, for purposes of preventing moisture accumulation within such structures, a layer of an openwork material can be applied over the water resistive covering before the exterior cladding is installed to thereby create drainage passageways and an open air space within the wall, roof or like building structure directly behind the exterior cladding. When such a material is installed within a wall, roof or like building structure, moisture penetrating the cladding is permitted to drain or/and evaporate and a better building envelope is provided that improves the sustainability of the building structure or home.

Examples of openwork materials for the above purpose are provided by U.S. Pat. No. 5,099,627 issued to Coulton et al. and U.S. Pat. Nos. 6,594,965 and 6,786,013 B2 issued to Coulton which are assigned to Benjamin Obdyke Incorporated, the assignee of the present application. Composite materials including a drainage-promoting material provided directly on and integral with a weather barrier or water resistive material have also been used. For example, see the materials disclosed in U.S. Pat. Nos. 7,607,270 B2 and 7,858,174 B2 issued to Ehrman et al. and U.S. Pat. Nos. 6,131,353 and 6,804,922 issued to Egan et al. which are co-assigned to Benjamin Obdyke Incorporated, the assignee of the present application. A further example of a composite material is provided by U.S. Pat. No. 5,826,390 issued to Sacks.

Although the openwork mats, building papers, house-wraps, and composite materials disclosed in the above referenced patents may function satisfactorily for their intended purposes, there remains a need for an inexpensive and alternate drainage-promoting wrap that can be utilized in an exterior wall, roof or like structural assembly of a building to quickly and efficiently drain moisture that penetrates exterior cladding of walls, roofs and like building structures. The drainage-promoting material should enable ready, efficient and easy installation requiring only a minimum of skill and should be capable of efficient and inexpensive manufacture.

### SUMMARY

The present invention is directed to a drainage-promoting wrap for a building structure and includes an elongate strip of weather-resistive membrane storable in a spiral roll and a series of separate, spaced-apart, spacer elements bonded to a face of the weather-resistive membrane. The spacer elements project from the face of the membrane to a predetermined height and are formed of a hot-melt material applied to the membrane.

According to some contemplated embodiments of the wrap, the wrap can also include a series of separate, spaced-apart, fastener tabs bonded to the face of the weather-resistive membrane. Each fastener tab is made of a material that self seals about a fastener when the fastener pierces the fastener tab and weather-resistive membrane.

According to another aspect of the present invention, a wall or roof assembly of a building is provided and includes an inner sheathing member and an exterior building material secured over the inner sheathing member and covering the inner sheathing member. The assembly also includes a drainage-promoting wrap applied within the assembly between the inner sheathing member and the outer building material. The wrap is a weather-resistive membrane having a series of separate, spaced-apart, spacer elements bonded to a face thereof and projecting from the face to a predetermined height. The spacer elements are formed of a hot-melt material and ensure that a proper amount of spacing is provided within the assembly for formation of drainage passages.

According to some contemplated embodiments of the building structure, a series of separate, spaced-apart fastener tabs are bonded to the face of the weather-resistive membrane and a series of fasteners pierce the fastener tabs, membrane, and inner sheathing member to secure the membrane to the inner sheathing member. The fastener tabs are made of a material that self-seals about the fasteners to prevent air or water infiltration through the membrane where the membrane is pierced by the fasteners.

### BRIEF DESCRIPTION OF THE DRAWINGS

The features and advantages of the present invention should become apparent from the following description when taken in conjunction with the accompanying drawings, in which:

FIG. 1 is a perspective view of a portion of a spiral roll of a drainage-promoting wrap according to the present invention;

FIG. 2 is a cross-sectional view of the wrap taken along line 2-2 of FIG. 1;

FIG. 3 is a perspective view with cut-away sections of an exterior wall assembly of a building according to the present invention;

FIG. 4 is a cross-sectional view of the wall assembly of FIG. 3; and

FIG. 5 an elevational view of a portion of an alternate drainage-promoting wrap according to the present invention.

### DETAILED DESCRIPTION

A moisture management building material or drainage-promoting wrap 10 is shown in roll form in FIG. 1. The material includes a weather or water resistive membrane 12 and a series of spacer elements 14 provided in a pattern on a face 12a of the membrane 12. In some contemplated embodiments of the present invention, a series of self-sealing fastener tabs 16 are also provided in a pattern on the face 12a of the membrane 12.

As shown in FIG. 1, the material 10 is preferably capable of being formed and provided of a relatively long length and rolled into a spiral roll 18 enabling efficient storage and shipment of a bulk quantity of the material 10 in a relatively compact package. The moisture management building material 10 can be unrolled at the building site and applied as a whether barrier covering during the assembly of an exterior wall, roof or like building structure.

Typically, the primary function of the membrane 12 is to provide a water and/or air infiltration barrier that resists passage or infiltration of water, moisture and/or air from the exterior environment surrounding the building structure to the interior of the building. Thus, the membrane 12 protects the inner sheathing members and like building elements of the building from damage or rot due to moisture penetrating the exterior cladding or like exterior building material which is exposed to the outside environment and weather conditions. A membrane 12 that is designed to resist air infiltration also greatly contributes to a building's energy efficiency. In addition, the membrane 12 may be made of a material that is said to be “breathable” to an extent to permit water vapor within the building to escape outwardly through the membrane 12 to a location behind the exterior cladding of a wall or roof structure.

Accordingly, the membrane 12 can be made of any weather barrier or water resistive sheet material that is sufficiently flexible as to be able to be stored and shipped in a spiral roll 18 and applied as a wrap over the inner sheathing members of a building. The membrane 12 is typically provided as an indefinite, relatively-long length of an elongate web of material that can be applied in continuous horizontally-extending rows across the inner sheathing members of the building. Merely by way of example, the total length of the membrane 12 within a new spiral roll 18 can be about 100 feet and it can have a width of 3, 5, 9 or 10 feet. Of course, other dimensions are also possible. The membrane 12 can be made of paper, tar paper, felt, roofing felt, a polymeric material, a thermoplastic material, a synthetic resin, olefin resin, polyolefin polymer, polypropylene, high density polyethylene, polystyrene, nylon, PVC or like house-wrap material. In addition, the membrane 12 can be a woven material, a non-woven material, a dry-laid non-woven material, a wet-laid non-woven material, a hybrid non-woven material, a polymer-laid non-woven material, a spun-bonded non-woven material, a flash-spun non-woven material, or the like.

The spacer elements 14 are applied to the face 12a of the membrane 12 during the manufacture of the moisture management building material 10 such that the spacer elements 14 are bonded to, and integral with, the membrane 12. Thus, as shown in FIG. 1, the spacer elements 14 are present within the spiral roll 18 as carried by the membrane 12. Thus, installation of the membrane 12 on inner sheathing members at a building site necessarily also simultaneously accomplishes installation of the spacer elements 14 thereby reducing installation time and costs.

The primary purpose of the spacer elements 14 is to space exterior cladding or like exterior building material from the face 12a of the membrane 12. Alternatively, the spacer elements 14 can be used to space the face 12a of the membrane 12 from inner sheathing members or the like depending upon which direction the face 12a of the membrane 12 is disposed. This spacing created by the spacer elements 14 provides a path for moisture to drain and/or air to flow within the building structure, typically direction behind the exterior cladding, thereby preventing moisture accumulation. For example, moisture penetrating the exterior cladding, or moisture vapor passing from the interior of the building through the membrane 12, may accumulate adjacent the face 12a. However, the spacing permits the moisture to drain along the face 12a of the membrane 12 such as under the force of gravity behind the cladding. Air circulation within this open space also helps to evaporate and remove moisture.

Simply for purposes of example, this space or gap provided by the spacer elements 14 between the face 12a of the membrane 12 and the exterior cladding may only need to be about 1 mm. Of course, the amount of spacing can be altered as desired by altering the height to which the spacer elements 14 extend from the face 12a during formation of the material 10. The 1 mm height of the spacer elements 14 is believed to provide a balance between needed spacing to ensure proper, quick and efficient drainage and economic considerations in manufacturing the moisture management building material 10.

The spacer elements 14 can be formed of a solidified hot-melt material, such as a hot-melt adhesive or the like, initially applied in a liquid or semi-liquid form to the face 12a of the membrane 12 before solidification. The pattern of spacer elements 14 applied to the membrane 12 needs to ensure that the spacer elements 14 are uniformly located throughout the face 12a of the membrane 12 so that the desired spacing is provided continuously throughout the building structure. However, the spacer elements 14 must only cover a minimum amount of the surface area of the face 12a of the membrane. This is because the pattern of spacer elements 14 must not cause draining moisture to become trapped by the presence of the spacer elements 14 and because the spacer elements 14 must permit the membrane 12 to remain “breathable” with respect to escape of water vapor from within the building through the membrane 12.

As shown in the drawings, the spacer elements 14 can be applied in the fowl of short-length, individual, line-segments or dashes 20 which are completely separate and spaced from one another. The open space between and around adjacent dashes provides an opening 22 through which moisture can drain and ambient air can flow. The dashes 20 can be arranged to provide a pattern of discontinuous lines 24 (i.e., alternating arrays of aligned dashes 20 and openings 22) generally extending along the length direction “A” of the membrane 12 (see FIG. 1) or across the width direction “B” of the membrane 120 (see FIG. 5). Of course, the discontinuous lines 24 of separate dashes 20 of spacer elements 14 can also extend diagonally across the face 12a, randomly across the face 12a, or in any other pattern.

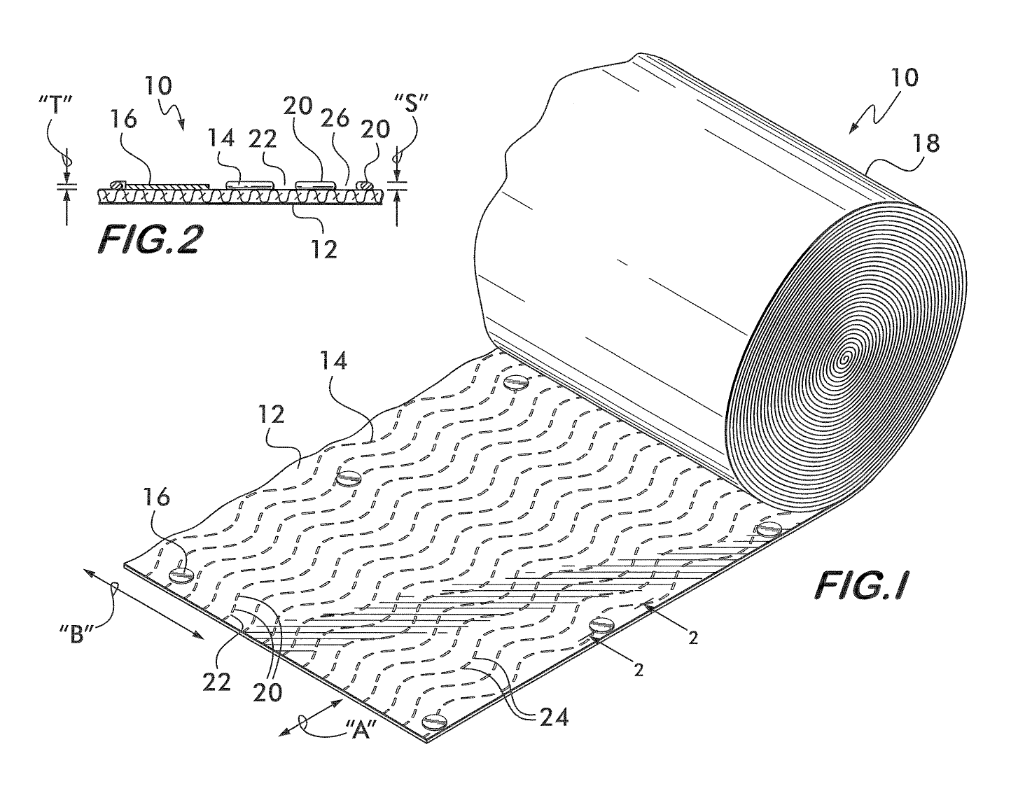

As one contemplated pattern of spacer elements 14, the dashes 20 can be arrange to form a uniformly arranged series of discontinuous undulating, wavy or sinusoidal lines 24. The corresponding dashes 20 in each adjacent line 24 can be aligned with each other as best illustrated in FIG. 2 to create unobstructed vertical drainage passages 26 across the face 12a of the membrane. Alternatively, the dashes 20 can be staggered as shown by the dashes of membrane 120 in FIG. 5.

By way of example, the length of each dash 20 may be about 0.4 inch or 10 mm and the spacing or opening 22 between each pair of dashes in the same line 24 may be about 0.4 inch or 10 mm. The thickness or height of each dash may be about 0.04 inch or 1 mm. The spacing between each discontinuous sinusoidal line 24 of dashes 20 may be about 1 inch and the amplitude of each wave of the line 24 may be about 1 inch. The wavelength of each line 24 may be about 4 inches. Of course, all these dimensions can be changed, as needed.

A pattern of self-sealing fastener tabs 16 can also be provided on the face 12a of the membrane 12. These tabs 16 provide landings, islands, or sites through which staples, nails or other mechanical fasteners 28 can be inserted to pierce the membrane 12 for purposes of securing the membrane 12 to inner sheathing members of a wall or roof. The tabs 16 are made of an elastic or elastomeric material that automatically seals about the shanks of the fasteners 28 and remains sealed about the shanks of the fasteners so that air and water infiltration is prevented at the piercing locations of the membrane 12.

As shown in the drawings, each tab 16 can be of a circular or other shape and be located at spaced-apart locations corresponding to locations where it may be desirable to secure the membrane 12 to an inner sheathing member. For instance, the pattern of tabs 16 may be spaced eight inches and or twelve inches apart in a grid type pattern. Thus, when the membrane 12 is applied to an inner sheathing member, the tabs 16 may be spaced eight inches apart in the horizontal direction and twelve inches apart in a vertical direction. Of course, other dimensions can be used.

The self-sealing tabs 16 may be made of the same hot-melt material as the spacer elements 14 or may be made of a different material. Preferably, the tabs 16 have a height “T” that is less than the height “S” of the spacer elements 14, such as about half the height. Thus, the tabs 16 do not interfere with the function of the spacer elements 14.

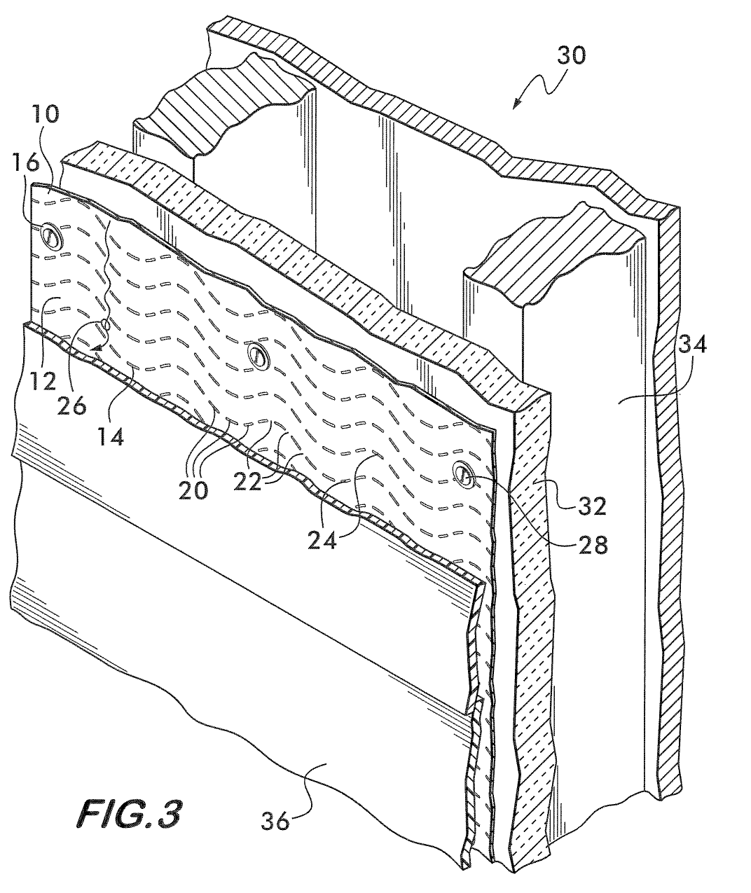

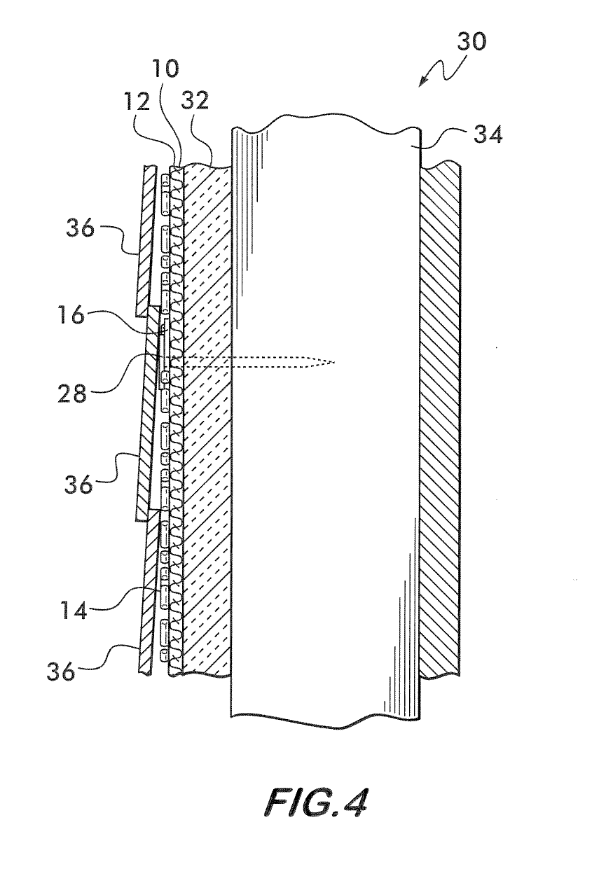

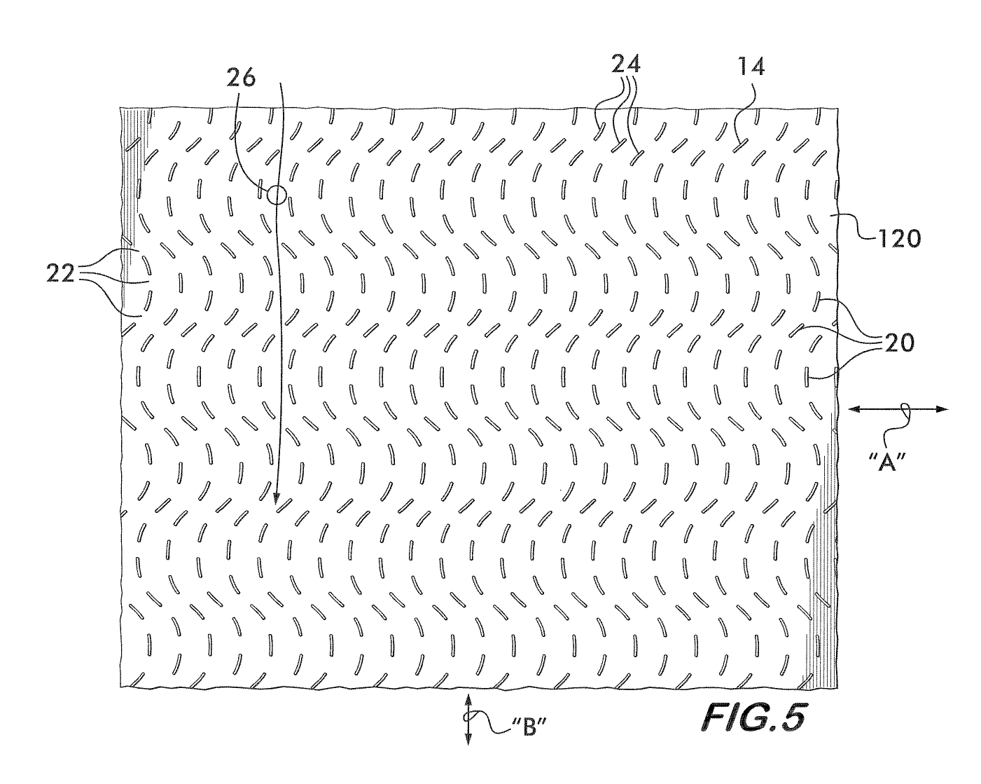

An assembly 30 of an exterior wall of a building is illustrated in FIGS. 3 and 4 and demonstrates the use of the moisture management building material 10. This or a similar assembly could also be utilized for an exterior roof or like other structure of a building. The assembly 30 includes generally-planar, sheet-like, inner sheathing members 32 affixed to vertically extending support posts 34. The inner sheathing members 32 are typically formed of panels of plywood, oriented strand board, particle board, insulated concrete, or other materials permitted by local building codes.

During installation of the assembly 30, the moisture management building material 10 is unrolled and secured as a covering on the inner sheathing members 32 such that the membrane 12 completely covers the inner sheathing members 32 and such that the spacer elements 14 and fastener tabs 16 face toward the building exterior. Typically, the elongate membrane 12 is secured to the inner sheathing members 32 with staples or like mechanical fastener 28 and extends continuously in a horizontal direction within the assembly 30. Several overlapping, horizontally-extending rows of the membrane 12 will typically be required to cover the entire elevation of the wall assembly 30.

An exterior building material 36, such as cladding, is affixed on the outer side of the assembly 30 such that it overlies the membrane 12 and sandwiches the membrane 12 between the inner sheathing member 32 and exterior cladding 36. The exterior cladding 36 can be, for instance, a wood or fiber-cement siding product or wooden shingles such as cedar shakes. The exterior building material 36 can also be brick, stone, stucco, exterior insulation finish systems (EIFS), vinyl, metal, asphalt, rubber, thermoplastic, and other exterior siding or roofing material.

As described above and shown in FIGS. 3 and 4, the spacer elements 14 space the face 12a of the membrane 12 from the exterior cladding 36, and the spaces, gaps, or openings 22 between the spacer elements 14 provide drainage and ventilation paths 26 within the assembly 26. Any moisture which penetrates the cladding 36 is provided with a path to drain downwardly under the force of gravity and out of the assembly 30. The space created by the spacer elements 14 also enables the circulation of air between the inner sheathing members 32 and exterior building material 36 to aid in drying or evaporating any moisture present within the assembly 30. The spacer elements 14 and openings 22 are located uniformly along the face 12a under the cladding 36.

The tabs 16 define the locations of fasteners 28 for securing the membrane 12 to the inner sheathing members 32. The tabs 16 can be aligned with the support posts 34 or alternatively the fasteners 28 can simply be secured to the inner sheathing members 32, such as by the use of staples or the like. The material of the tabs 16 prevents undesired tearing of the membrane and self-seals about the shank or shanks of the fastener 28. This maintains the water and air infiltration barrier provided by the membrane 12 despite the piercing of the membrane 12 with the fasteners 28.

In addition, when applying individual cladding boards to the wall, the pattern of spacer elements 14 can be used to provide site lines to ensure that the boards are installed in a level condition. For instance, the peaks of one of the undulating lines 24 of spacer elements 14 can be used to properly align the board with the horizontal and properly space the board to provide uniform overlap. Thus, the pattern of spacer elements 14 can also be used to provide visual indicators with respect to aligning and installing cladding boards 36 and the like.

Accordingly, the above-described drainage-promoting wrap and wall and roof assemblies according to the present invention provide a cost effective building product for use in managing moisture within wall, roof and other exterior building structures.

While preferred wraps and assemblies have been described in detail, various modifications, alterations, and changes may be made without departing from the spirit and scope of the present invention as defined in the appended claims.

1. A drainage-promoting wrap for a building structure, comprising:
an elongate strip of weather-resistive membrane storable in a spiral roll, and
a series of separate, spaced-apart, spacer elements bonded to a face of said weather-resistive membrane and projecting therefrom to a predetermined height, said spacer elements being formed of a hot-melt material.

2. A drainage-promoting wrap according to claim 1, further comprising a series of separate, spaced-apart, fastener tabs bonded to said face of said weather-resistive membrane, said fastener tabs being of a material that self seals about a fastener when the fastener pierces the fastener tab and weather-resistive membrane.

3. A drainage-promoting wrap according to claim 2, wherein said fastener tabs are formed of the same hot-melt material as said spacer elements.

4. A drainage-promoting wrap according to claim 2, wherein said fastener tabs are formed of an elastomeric material.

5. A drainage-promoting wrap according to claim 2, wherein said fastener tabs project to a predetermined height from said face said membrane that is less than said predetermined height of said spacer elements.

6. A drainage-promoting wrap according to claim 2, wherein each of said spacer elements is in the form of a short-line segment or dash, wherein a plurality of said dashes form a series of uniformly spaced-apart discontinuous undulating lines across said face of said membrane, and wherein spacing between adjacent dashes in the same discontinuous undulating line and in adjacent discontinuous undulating lines forms drainage passages on said face of said membrane.

7. A drainage-promoting wrap according to claim 6, wherein said series of discontinuous undulating lines extend in a length direction of said elongate membrane from one end of said membrane to an opposite end of said membrane.

8. A drainage-promoting wrap according to claim 6, wherein said series of discontinuous undulating lines extend in a width direction of said elongate membrane from one side edge of said membrane to an opposite side edge of said membrane.

9. A drainage-promoting wrap according to claim 6, wherein said predetermined height of each of said dashes is about 1 mm.

10. An assembly of an exterior building structure, comprising:
an inner sheathing member;
an exterior building material secured over said inner sheathing member and covering said inner sheathing member; and
a drainage-promoting wrap applied within the assembly between said inner sheathing member and said outer building material, said wrap comprising a weather-resistive membrane having a series of separate, spaced-apart, spacer elements bonded to a face of said weather-resistive membrane and projecting therefrom to a predetermined height, said spacer elements being formed of a hot-melt material and providing drainage passages within the assembly.

11. An assembly according to claim 10, wherein said face of said drainage-promoting wrap from which said spacer elements project faces said exterior building material and is spaced from said exterior building material by said spacer elements.

12. An assembly according to claim 10, wherein said face of said drainage-promoting wrap from which said spacer elements project faces said inner sheathing member and is spaced from said n sheathing member by said spacer elements.

13. An assembly according to claim 10, further comprising a series of separate, spaced-apart fastener tabs bonded to said face of said weather-resistive membrane and a series of fasteners that pierce said fastener tabs, membrane, and inner sheathing member and secure said membrane to said inner sheathing member, said fastener tabs being made of a material that self-seals about said fasteners to prevent air or water infiltration through said membrane where said membrane is pierced by said fasteners.

14. An assembly according to claim 13, wherein said fastener tabs are formed of the same hot-melt material as said spacer elements.

15. An assembly according to claim 13, wherein said fastener tabs are formed of an elastomeric material.

16. An assembly according to claim 13, wherein said fastener tabs project to a predetermined height from said face of said membrane that is less than said predetermined height of said spacer elements.

17. An assembly according to claim 13, wherein each of said spacer elements is in the form of a short-line segment or dash, wherein a plurality of said dashes form a series of uniformly spaced-apart discontinuous undulating lines across said face of said membrane, and wherein spacing between adjacent dashes in the same discontinuous undulating line and in adjacent discontinuous undulating lines forms drainage passages on said face of said membrane.

18. An assembly according to claim 17, wherein said series of discontinuous undulating lines extend in a length direction of said elongate membrane and horizontally within said assembly.

19. An assembly according to claim 17, wherein said series of discontinuous undulating lines extend in a width direction of said elongate membrane from one side edge of said membrane to an opposite side edge of said membrane and vertically within said assembly.

20. An assembly according to claim 17, wherein said predetermined height of said dashes is about 1 mm, and wherein said dashes provide a 1 mm gap between said inner sheathing member and said exterior building element uniformly throughout the entire assembly.
